(19) United States
(12) Patent Application Publication
(10) Pub. No.: US 2024/0383582 A1
(43) Pub. Date: Nov. 21, 2024

(54) Marine Cleaning

(71) Applicant: CLEANSUBSEA OPERATIONS PTY LTD, Bibra Lake (AU)

(72) Inventors: Dirk van der Roest, Bibra Lake (AU); Aaron Pytte, Bibra Lake (AU)

(21) Appl. No.: 18/684,667

(22) PCT Filed: Aug. 24, 2022
(86) PCT No.: PCT/AU2022/050988

§ 371 Date: Feb. 17, 2024

(30) Foreign Application Priority Data
Aug. 25, 2021 (AU) 2021221633

(51) Int. Cl. B63B 59/08; B08B 1/14; B08B 1/30; B08B 5/04

(52) U.S. Cl. CPC B63B 59/08; B08B 1/14; B08B 1/30; B08B 5/04

(57) ABSTRACT

A cleaning machine (10) for cleaning a submerged surface (11) has a drive device (12) and at least one cleaning head (14) disposed forward of the drive device in a forward direction of travel of the cleaning machine. The drive device has a pump (20). a pump inlet (22) for receiving material cleaned from the submerged surface, and a pump outlet (24) for output of the material, and traction means (18) for propelling the cleaning machine along the submerged surface, wherein contact of the traction means with the submerged surface is within a width cleaned by the at least one cleaning head (14). The at least one cleaning head is supported by a support structure (70) projecting form the drive device (12). One or more magnets (36) can be positioned by coarse and/or fine distance adjustment relative to the submerged surface.

### FIELD OF THE INVENTION

The present invention relates to marine cleaning.

Particularly, one or more arrangements, equipment and/or systems for use in cleaning an underwater portion of a vessel hull or other underwater structure.

### BACKGROUND TO THE INVENTION

It is known that an underwater portion of a vessel or an underwater portion of a structure can become increasingly fouled over time with marine growth. Such biofouling occurs when organisms attach to and grow on the submerged parts of a vessel or structure, increasing in depth and surface area over time. Vessel structures at risk of biofouling include the hull surface, propellers, anchors, niche areas and fishing equipment.

Non-native marine species can be inadvertently transported into regions previously unaffected by a particular marine species, risking non-native marine species invasion, biodiversity protection and subsequent damage to native species and marine habitats, such as corals, and have adverse economic and health effects.

If such fouling is not removed from the vessel hull or structure, significant problems can occur, including damage to the vessel hull or structure and, in the case of a marine vessel, a reduction in seafaring performance and fuel economy of the vessel and corresponding increase in GHG emissions.

Uncontrolled in-water cleaning can release chemical and biological contaminants into the local environment, and for example may stimulate the release of reproductive propagules, or plant and animal fragments capable of regeneration.

In order to avoid release of such contaminants into the local marine environment, conventional vessel hull cleaning techniques have involved removing the vessel from the water, and subsequently cleaning the vessel hull. However, this approach is expensive and time consuming.

In AU2012244227 a cleaning head is disclosed for cleaning a submerged surface. Embodiments of the cleaning head have a body portion, a skirt portion extending around a periphery of the body portion, and rotatable blades that contact and move relative to the submerged surface to cause material on the submerged surface to separate from the submerged surface. Separated material is drawn away from the cleaning head through a suction aperture by a pump.

The present invention seeks to address or at least provide an alternative to prior systems.

It is to be understood that, if any prior art is referred to herein, such reference does not constitute an admission that the prior art forms a part of the common general knowledge in the art, in Australia or any other country.

### SUMMARY OF THE INVENTION

Disclosed is a cleaning machine for cleaning a submerged surface, the cleaning machine comprising: a drive device and at least one cleaning head, the at least one cleaning head disposed forward of the drive device in a forward direction of travel of the cleaning machine, the drive device including:
a pump, a pump inlet for receiving material cleaned from the submerged surface, and a pump outlet for output of the material, and
traction means for propelling the cleaning machine along the submerged surface,
wherein the traction means is within a width cleaned by the at least one cleaning head.

Also disclosed is a drive device for a cleaning machine for cleaning material from a submerged surface, the drive device including a pump, a pump inlet for receiving material cleaned from the submerged surface, and a pump outlet for output of the material, and traction means for propelling the cleaning machine along the submerged surface, the traction means including front wheels and rear wheels, wherein the pump is located between front and rear wheels.

Also disclosed is a cleaning head for a cleaning machine for cleaning material from a submerged surface, the cleaning head including at least one cleaning pod, at least one said cleaning pod including a housing for a cleaning device, such as at least one rotatable blade, wherein the respective cleaning pod includes at least part of a pivot or swivel arrangement provided to allow the housing of the cleaning pod to pivot or swivel about a front to rear axis of the cleaning head or the cleaning machine.

First physical contact of the cleaning machine with the material to be cleaned/removed from the submerged surface or the submerged surface can be by a cleaning device of the at least one cleaning head, such as a cleaning blade.

Alternatively, first physical contact of the cleaning machine with the submerged surface can be by the traction means provided behind the at least one cleaning head subsequent to the submerged surface being cleaned of the material from the submerged surface.

The pump inlet may be ahead/in front of the pump. The pump outlet may be rearward of the pump. The pump inlet may be lower (nearer to the submerged surface) than the pump outlet.

One or more of the pump inlet, the pump and the pump outlet may be lower (nearer to the submerged surface) than an upper boundary/edge of the traction means. For example, an upper extent of a wheel or the wheels of the traction means may be higher/above the inlet, the pump and or the pump outlet.

The pump outlet may be angled upward/not directly rearward to direct flow away from the drive device and reduce leverage and/or ease umbilical hose handling and related control of the cleaning machine.

The pump may be provided between front traction means and rear traction means. This helps to lower the centre of gravity of the drive device and/or helps to reduce leverage by an umbilical connected between the drive device/pump and a filtration system that is not underwater. Preferably the front traction means is/are provided between the pump and the at least one cleaning head.

The pump may be integrated into/from part of a chassis or sub-chassis of the drive device. Thus, the pump may provide an integral structural part of the drive device, preferably with components connected thereto, such as the traction means and/or magnets/magnet deployment arrangement for selective/controllable magnetic adhesion of the cleaning machine to the submerged surface.

Magnetic adhesion may be provided by magnets being selectively and/or controllable positionable with respect to the drive device. In particular, magnets may be positioned towards the submerged surface to magnetically attract/adhere the cleaning machine to a suitable metal said submerged surface (e.g. iron based-such as steel).

The magnets may be provided towards a rear of the drive device to help reduce/resist dragging and/or peeling forces resulting from the trailing umbilical and hoses. The magnets may include at least one magnet to be positioned adjacent a respective rear traction means (such as a wheel) of the drive device. At least one said magnet positioned between, and deployable/retractable between, two adjacent traction means (such as adjacent wheels (e.g. at one end and side) of the drive device.

Magnet positioning or deployment means may include at least one actuator assembly, which may include at least one actuator, such as an electric (e.g. motor driven actuator), or pneumatic or hydraulic actuator, e.g. at least one ram (double acting or single acting with return biasing means/spring). The at least one actuator assembly may actuate rotational positioning and/or retraction of at least one said magnet. For example, at least one said magnet may be provided on a linkage rotationally pivotable and driven by the at least one actuator.

The magnet positioning/deployment means may include at least one actuator assembly providing rotation positioning/deployment and/or retraction of at least one magnet. The magnet positioning/deployment means may include coarse positioning and/or fine positioning of the at least one magnet relative to the submerged surface. Coarse positioning has less fine control over positioning the magnet(s) relative to the surface than the fine positioning.

For example, the magnet positioning or deployment means may include coarse positioning (distance D_{C}, FIG. 5B) and fine positioning (D_{F}, FIG. 5C) capability, and control of position variability therebetween. For example, the magnet positioning/deployment means may include rotational positioning/deployment and cam actuated fine distance positioning of the respective magnet relative to the submerged surface (See FIGS. 5B and 5C).

At least one said magnet may be positioned towards a rear of the cleaning machine for attraction of the cleaning machine to the surface to be cleaned or being cleaned. Preferably the at least one said magnet is positioned between the front and rear traction means of the cleaning machine.

At least one support arrangement may project/extend from the drive device to support at least a part of the respective cleaning head. The support arrangement may connect to the drive device between front and rear traction means of the drive device and projects to connect to the cleaning head.

The at least one cleaning head may include at least one cleaning pod having a cleaning device and a housing about the cleaning device. A pump suction outlet may be connected to the housing such that fluid and material cleaned from the submerged surface below the cleaning pod flows out of the housing and through the pump suction outlet to the pump.

One or more said cleaning pod may include forward and rearward pivot/swivel connections such that the respective cleaning pod is enabled to pivot/swivel about a front to rear axis to aid conforming the cleaning head to a profile/curve of the submerged surface to be cleaned.

The at least one cleaning head may maintain the or each cleaning pod clear of the submerged surface during cleaning i.e. zero contact of the or each cleaning pod (and therefore zero contact of the respective cleaning device e.g. flexible or solid blade(s)) with the submerged surface.

At least one said cleaning pod may have at least one castor or other wheel or track directly or indirectly attached/mounted thereto to help support and/or stabilise the respective cleaning pod and/or the at least one cleaning head.

The respective castor, wheel or track may be provided between or at least behind a more forward said cleaning pod. For example, the at least one cleaning head may include multiple cleaning pods, with at least one support castor, wheel or track behind at least one leading cleaning pod and/or between a leading cleaning pod and a trailing cleaning pod.

The at least one castor, wheel or track may be mounted to the respective cleaning pod, such as by a clamp or bracket.

The respective cleaning pod may include at least two castors, wheels or tracks, preferably with a respective pivot or swivel connection therebetween.

The at least one castor, wheel or track may be provided trailing a more forwardly disposed cleaning pod.

The cleaning head may be supported by connection to the drive device.

One or more rearward cleaning pods (rearward with respect to more forward positioned cleaning pods) may be pivotably connected to the drive device.

At least one support arm or frame may extend from the drive device to support at least a part of the respective cleaning head.

Drive to the cleaning device of the respective cleaning pod may be provided by flow of fluid through the cleaning pod provided by suction by the pump.

Alternatively, drive to the cleaning device may be provided by electric, pneumatic or hydraulic drive, and the pump suction generates the fluid flow through the cleaning pod.

The cleaning device can include a rotary device including at least one blade.

The respective cleaning pod may include a shroud or skirt that controls and/or maintains suction and fluid flow via a gap between a lower surface of the shroud/skirt and the submerged surface.

The at least one cleaning device causes material on the submerged surface to separate from the submerged surface when the cleaning head is disposed on the submerged surface during use and the respective cleaning device moves relative to the submerged surface.

During use, when the cleaning machine is disposed on the submerged surface and at least one suction aperture is connected in fluid communication with the cleaning head for generating a negative pressure, the material separated from the submerged surface by the at least one cleaning device is drawn away from the cleaning head through the suction aperture; and the at least one cleaning pod is arranged and configured not to contact the submerged surface during use, the shroud or skirt of each respective cleaning pod having a gap thereunder to the submerged surface.

Embodiments include a method of cleaning a submerged surface includes: disposing a cleaning machine on the submerged surface, cleaning the submerged surface while moving the cleaning machine across the submerged surface, and contacting traction means of the cleaning machine with the submerged surface within a width cleaned by at least one cleaning head of the cleaning machine.

### BRIEF DESCRIPTION OF THE DRAWINGS

It will be convenient to further describe the invention with reference to preferred embodiments of the present invention. Other embodiments are possible, and consequently the particularity of the following discussion is not to be understood as superseding the generality of the preceding description of the invention. In the drawings:

FIGS. 1A to 1D show examples of a cleaning machine according to at least one embodiment of the present invention tracking within the cleaned area.

FIG. 1E shows a side view of a cleaning machine drive device coupled to a cleaning head according to an embodiment of the present invention.

FIGS. 1F shows a side view and FIG. 1G shows a perspective view of a cleaning machine with conduits connection cleaning pods of a cleaning head to a pump arrangement of a drive device, and outlet conduit and umbilical to extend to the surface, according to an embodiment of the present invention.

FIGS. 2A to 2D show various views of a drive device according to an embodiment of the present invention.

FIGS. 3A to 3C and 4A to 4B show various views of cleaning pods according to at least one embodiment of the present invention.

FIGS. 5A to 5C show positional views of a magnet positioning/deployment arrangement according to an embodiment of the present invention.

FIGS. 6A and 6B show views of the magnet positioning/deployment arrangement with the magnet(s) retracted towards a respective keeper according to an embodiment of the present invention.

FIGS. 7A and 7B show views of the magnet positioning/deployment arrangement with the magnet(s) deployed/positioned away from a respective keeper according to an embodiment of the present invention.

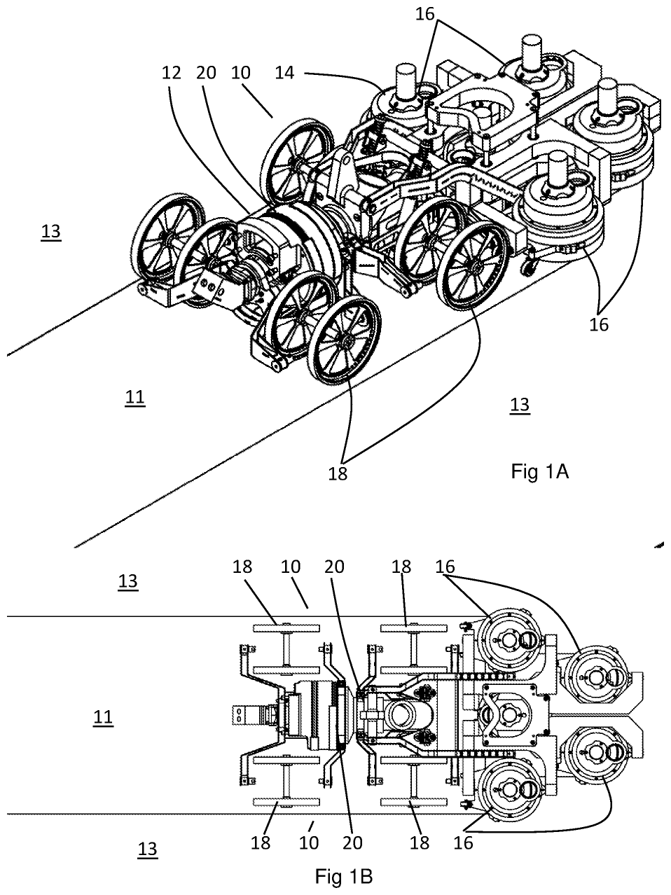

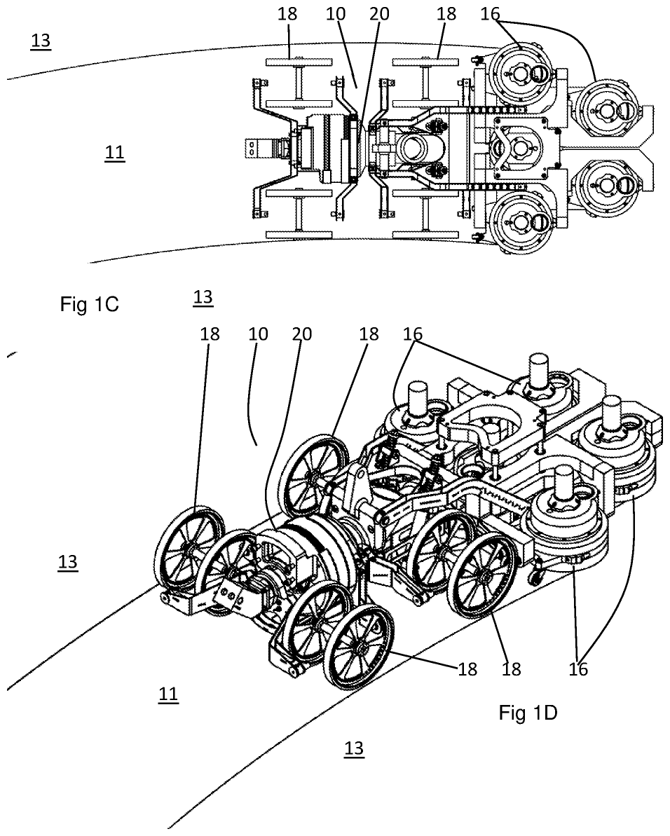

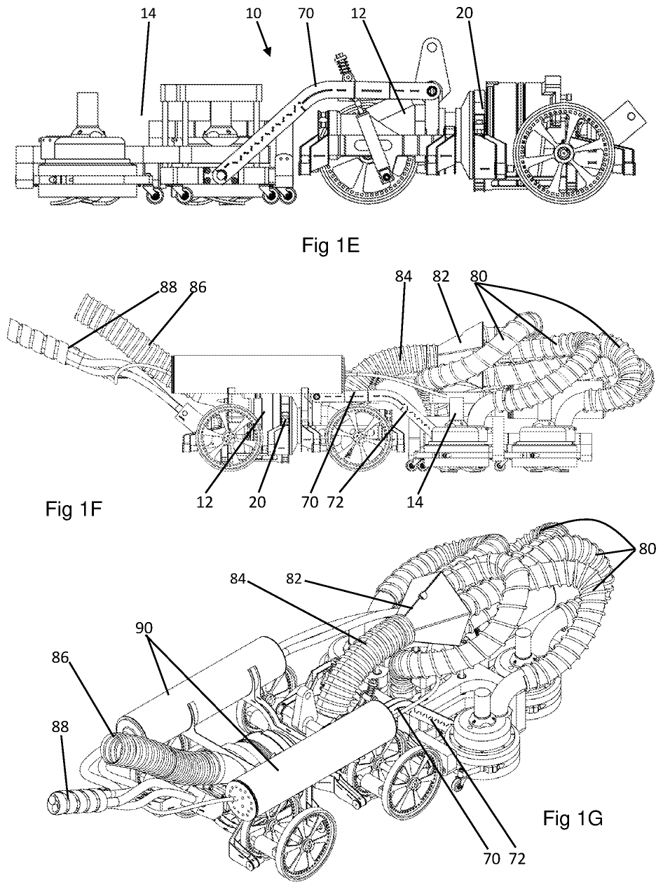

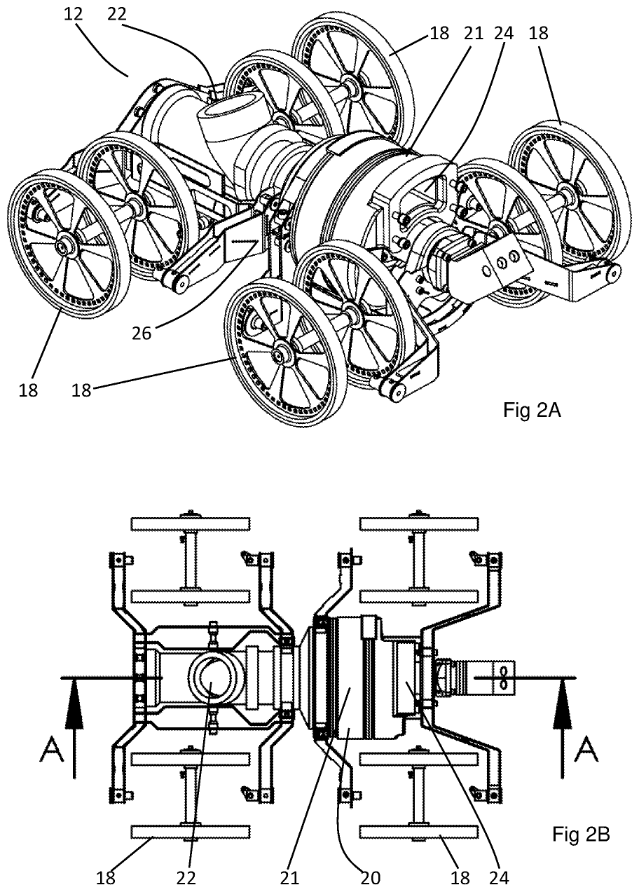

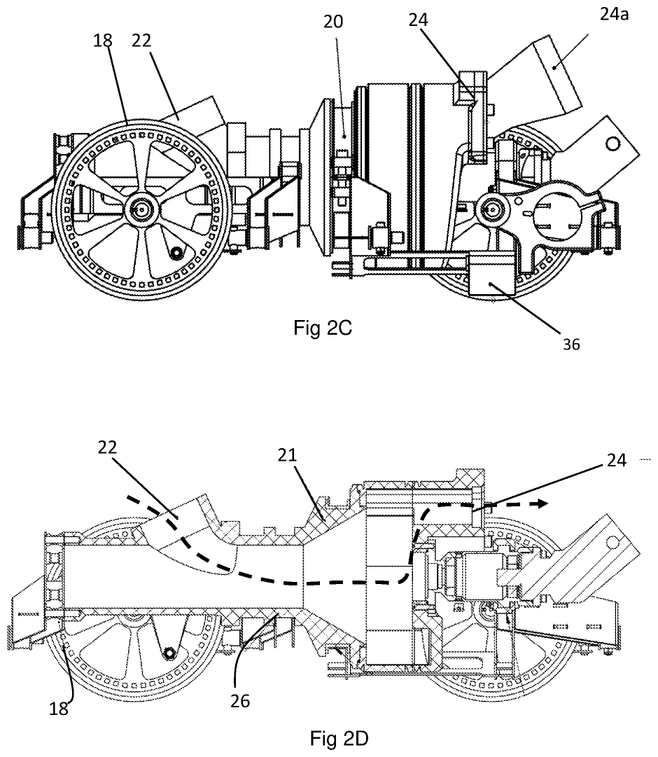

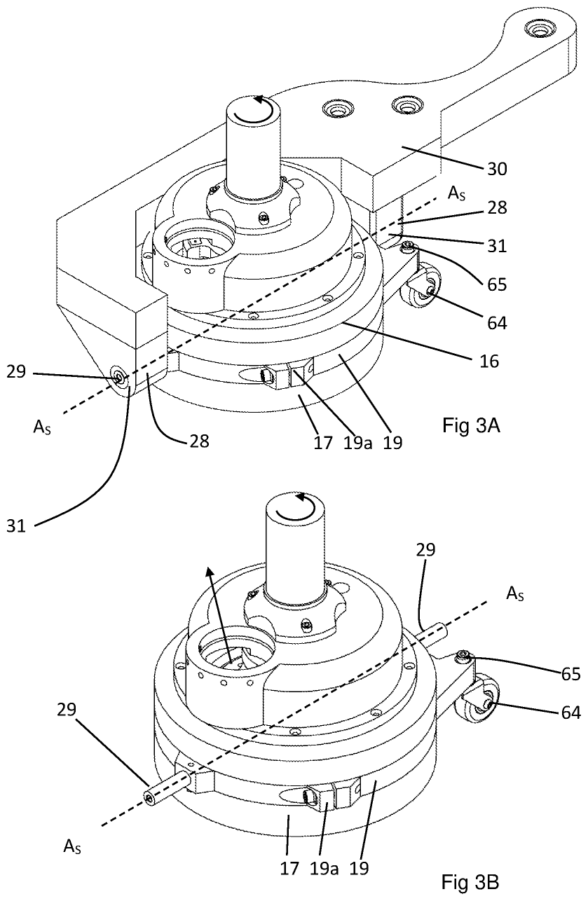

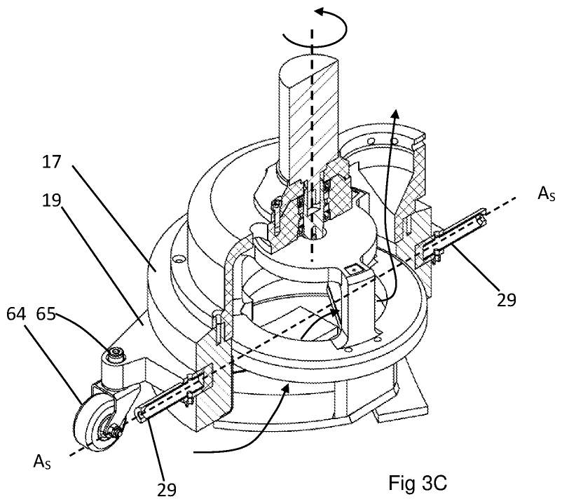

### DETAILED DESCRIPTION OF PREFERRED EMBODIMENT(S)

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

Embodiments of the present invention a cleaning machine 10 for cleaning a submerged surface, such as a marine vessel hull, storage tank, or other submerged structure 13. The cleaning machine 10 is particularly efficacious for cleaning a submerged hull of a marine vessel.

It will be appreciated that contact on the surface 13 of the vessel or structure is only on cleaned areas 11 thereof. That is, the cleaning machine cleans an area and the wheels or tracks, and any castors or other supports on the surface, only contact areas already cleaned by the cleaning machine.

The cleaning machine 10 has a drive device 12 for imparting motion to the cleaning machine and a cleaning head 14 for removing material from the submerged surface. The at least one cleaning head can include one or more, preferably multiple, cleaning pods 16.

The drive device can include traction means 18, such as multiple wheels. The wheels may have tyres/treads to engage with the submerged surface or may drive tracks.

Drive force to the wheels 18 on opposite sides of the drive device can be different. For example the cleaning machine can have differential steering by the wheels on one side of the drive device being powered more than the wheels on the other side of the drive device, or powered to rotate in a different direction. Such control over differentially powering the wheels on either side of the drive device provides for enhanced steering and manoeuvrability characteristics. Differential drive to tracks instead of wheels, or combinations of tracks and wheels can also be provided.

Drive to the wheels/tracks 18 can be hydraulic, such as by hydraulic pressure/power provided via at least one hose from the surface.

For example, in the case of hydraulic drive to the wheels 18, hydraulic power may be provided more to the wheels on one side of the drive device than the other, or the hydraulic power may be reversed or diverted to flow in an opposite direction to reverse or stop the wheels on one side of the drive device relative to the wheels on the other side. Consequently, the cleaning machine can be highly manoeuvrable, and can turn very tightly or turn on the spot.

A pump 20 can be provided as part of the drive device. A main body 21 of the pump can be predominantly or completely located between front and rear sets of wheels 18 of the drive device, enabling relatively low centre of mass because the pump is a relatively large and heavy component-lowering the centre of mass also reduces tendency for the connected umbilical and hoses to lever the cleaning machine from the submerged surface.

A pump inlet 22, the pump 20 and a pump outlet 24 can be provided inline, preferably with the inlet leading i.e. towards a front of the cleaning machine, the pump 20 in the middle and the outlet 24 facing rearward. Preferably the outlet is angled upward/away from the submerged surface, such as by an outlet extension 24a. Having the angled outlet also helps to reduce induced peeling effects from the umbilical and hoses.

The pump can form part of a chassis or sub-chassis 26 of the drive device 12. Wheel supports can be mounted to the chassis/sub-chassis 26.

The pump inlet 22 can be connected by hoses 80 to outlets 32 of the cleaning pods for flow of fluid and removed material to be pumped by the pump 20 via the pump outlet 24 to a filtration system at the surface. The hoses 80 can feed removed material into a material receiving conduit 84, such as via manifold or receiving head 82. The pump outlet 24 can supply the removed material under pressure from the pump 20 via supply conduit 86 to the surface. An umbilical arrangement 88, such as including hydraulic and/or electrical supplies, connects to the cleaning machine form the service for control and power operations of the cleaning machine.

One or more swivel/pivot arrangements 28 can be provided, such as between the drive device one or more of the cleaning pods and/or between cleaning pods. The one or more swivel/pivot arrangements 28 may include a swivel/pivot pin 29 and a swivel/pivot pin receiver 31. The one or more cleaning pods 16 of the cleaning head 14 can be mounted by the swivel/pivot arrangements. It will be appreciated that the cleaning pods could have the swivel/pivot pin(s) 29 and the swivel/pivot pin receiver(s) 31 can be on supports 30, or vice versa. The supports 30 can connect between the drive device 12 and the cleaning pods.

Preferably the swivel/pivot axis As for each swivel/pivot arrangement 28 e.g. for each swivel/pivot pin 29 providing swivel/pivot mounting for the respective a cleaning pod 16 are axially aligned.

A magnet positioning/deployment means 32 can include at least one actuator assembly 34 can be provided on the drive device 12 to position/deploy and retract at least one magnet 36 for use in magnetically adhering the drive device, and therefore the cleaning machine, to the submerged surface.

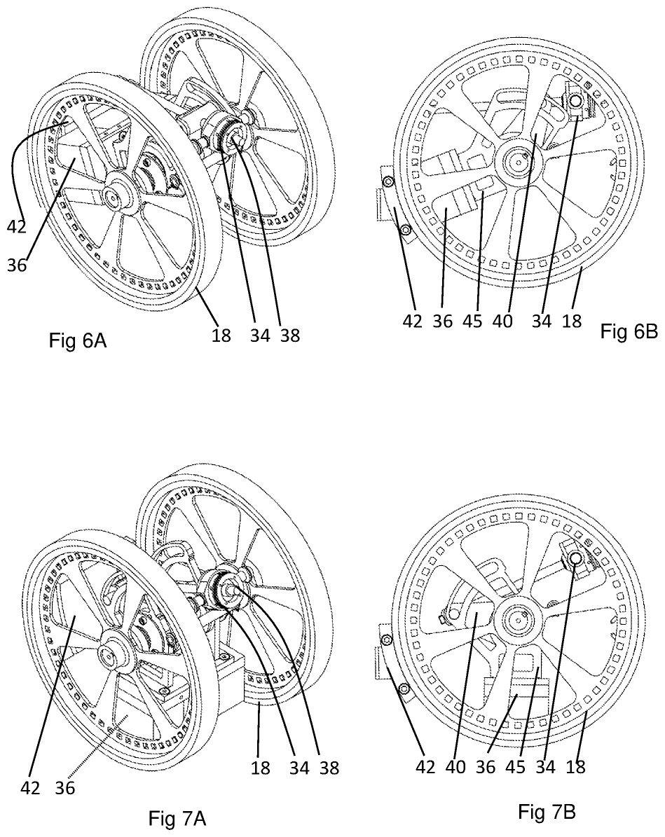

The magnet 36 may be mounted for pivoting motion between two adjacent wheels 18. See, by way of example, FIGS. 6A, 6B, 7A and 7B showing retracted (6A, 6B) and deployed (7A, 7B) positions of the respective magnet 36 using the magnet positioning/deployment means 32 (e.g. including at least one actuator assembly 34).

The at least one actuator assembly 34 can include at least one actuator 38 (such as an electric drive, pneumatic or hydraulic ram) arranged and configured to actuate a rotational linkage or member 40 to rotate the respective magnet 36 from a stowed position to a deployed position, and the retract the deployed magnet 36 from the deployed position to the stowed position. In the stowed position, the respective magnet 36 may be attracted to a keeper 42 (such as a steel keeper plate) to help ensure the magnet cannot accidentally deploy.

The at least one actuator assembly can include coarse and fine magnet positioning. For example, initial rotation of the respective magnet from a stowed position to a deployed position can provide coarse positioning, such that the magnet may be further away from the submerged surface than is ideal for the necessary amount of attraction to the surface (i.e. due to the depth of material and/or density or type of material present on the surface).

Fine positioning can reduce the gap between the respective magnet and the surface to increase magnetic attraction and help retain the cleaning machine to the submerged surface.

Fine positioning can be by a cam arrangement 52, such that initial actuation of the actuator rotates the magnet to an initial position, and further actuation moves the magnet closer to the submerged surface.

The respective actuator can actuate a threaded drive 44, such as a worm drive, engaged with the linkage or member 40 to rotate the linkage or member 40.

The at least one said magnet 36 may be provided on a pivot member 45 rotationally pivotable and driven by or allowed movement by a pivot link member 46.

The pivot member 45 can include an arcuate slot 48 within which is received a drive member 50 actuated by the actuator 38. Advancement of the drive member 50 within the arcuate slot 48 causes the the linkage or member 40 to rotate and therefore the pivot member 45 and the magnet rotates away from the keeper plate 42 towards a magnet deployed position.

Further advancement of the drive member 50 within the arcuate slot 48 causes a cam arrangement 52 to move the magnet 36 closer to the submerged surface.

The gap between the magnet and the submerged surface can be controlled by actuation of the actuator to move the cam arrangement and thereby apply fine distance control/positioning of the magnet relative to the submerged surface.

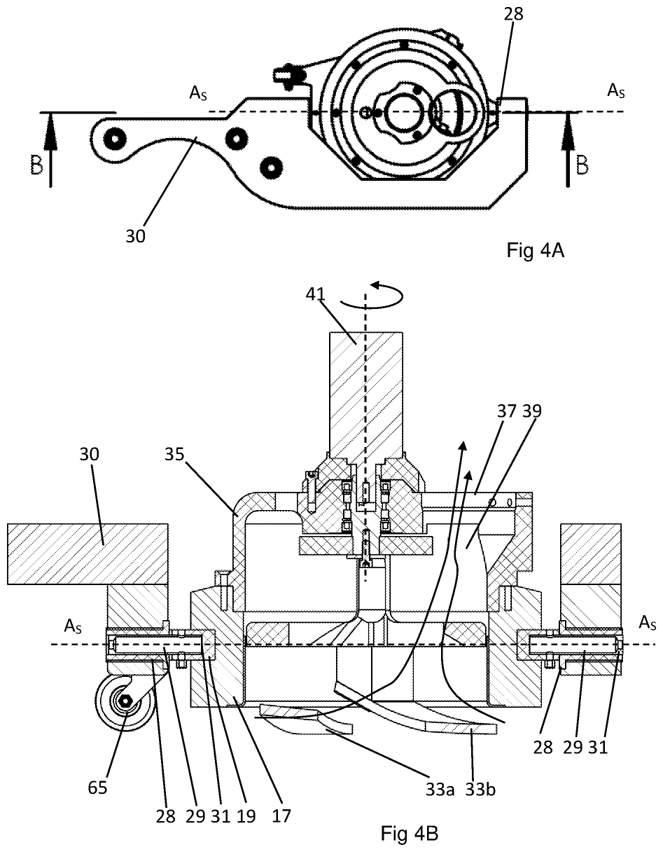

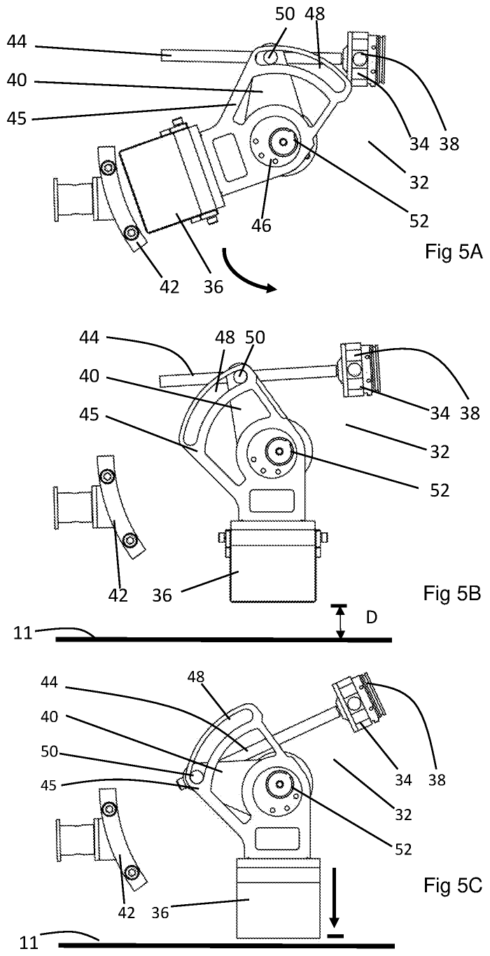

The magnet positioning/deployment means may include coarse positioning/deployment and fine positioning/deployment capability—e.g. coarse positioning distance control (D_{C}, FIG. 5B) and fine positioning distance control (D_{F}, FIG. 5C). For example, the magnet deployment means may include rotational deployment and cam actuated fine distance positioning of the respective magnet relative to the submerged surface.

The cleaning head 14 has at least one cleaning pod 16 including a housing 54 for a cleaning device 56, such as at least one rotatable blade 58 on a rotatable support, preferably powered by hydraulic flow (such as by a hydraulic hose connected to the respective pod 16) or flow by suction through the housing.

The respective cleaning pod 16 includes at least part of a pivot or swivel arrangement 60, 62 provided to allow the housing 54 of the cleaning pod to pivot or swivel about a front to rear axis (axis F-R) of the cleaning head or the cleaning machine. The swivel/pivot arrangement for each cleaning pod can allow the pods of a cleaning head to conform generally to the shape of the surface. For example, a marine vessel hull can have compound curves, curving longitudinally to one radius of curvature (which radius can transition) and a different radius of curvature vertically (again, such a radius can transition). The swivel/pivot arrangements provide a gimbal arrangement, preferably on at least one front to rear swivel/pivot axis Aₛ, allowing the cleaning pods to move relative to one another such that the overall cleaning head can generally follow the curvature of the surface being cleaned.

A castor or castors 64 supports the respective cleaning pod 16 by contact with the cleaned portion of the submerged surface i.e. the castor or castors 64 follows a preceding cleaning pod 16 of the cleaning head 14.

The or each castor 64 can be mounted to the respective cleaning pod 16 by a respective castor swivel/pivot arrangement 65.

Connection of the cleaning head 14 to the drive device 12 can be at one or more connection points at the front of the drive device 12 and/or by a support arrangement 70 extending between the drive device and the cleaning head. The support arrangement 70 can include at least one support arm or frame 72. It will be appreciated that the support arrangement 70 connects to the drive device 12 between the front and rear wheels thereof, helping to reduce the centre of gravity and help with stabilisation of the entire cleaning machine 10. Leverage effect of the forward weight of the cleaning head 14 is reduced compared to connecting the cleaning head to the drive device in front of the front wheels. Preferably the support arrangement connects to a central portion of the drive device, such as the pump/pump housing 20, 21. The support arrangement can include one more arms, preferably two arms, extending from the pump housing to the cleaning head.

First physical contact of the cleaning machine with the material to be cleaned/removed from the submerged surface or the submerged surface can be by a cleaning device 33 of the at least one cleaning head 14, such as a cleaning blade 33a, 33b. The or each clean blade may be flexible, partially flexible or rigid. Preferably the or each blade does not contact the surface to be cleaned.

One or more of the cleaning pods can include a rotary drive 41 for rotational drive to the blade(s) 33. The rotary drive can include hydraulic or pneumatic drive. Material removed from the surface by the blade(s) 33 can be removed via an outlet 37 from a chamber 39 of the cleaning pod.

The or each cleaning pod can include a body portion 17, which may include a foam material. The foam material may include a hard foam material, preferably with a coating, such as a wear resistant/polymer coating.

The body portion may be a replaceable/consumable/wear part that can be changed without the need to replace or remove the cleaning pod. For example, a retaining means 19 may include a releasable retainer 19a that can be released for removal of the body portion and, after insertion of a replacement body portion, retightened, such as a band and clamp arrangement.

First physical contact of the cleaning machine with the submerged surface can be by the traction means provided behind the at least one cleaning head after the submerged surface being cleaned of the material from the submerged surface.

Modifications and variations as would be apparent to a skilled addressee are deemed to be within the scope of the present invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-16. (canceled)

17. A cleaning machine for cleaning a submerged surface, the cleaning machine comprising: a drive device and at least one cleaning head, the at least one cleaning head disposed forward of the drive device in a forward direction of travel of the cleaning machine, the drive device including: a pump, a pump inlet for receiving material cleaned from the submerged surface, and a pump outlet for output of the material, and traction means for propelling the cleaning machine along the submerged surface, wherein contact of the traction means with the surface is within a width cleaned by the at least one cleaning head.

18. The cleaning machine of claim 17, wherein the pump is between front traction means and rear traction means.

19. The cleaning machine of claim 17, wherein the pump is an integral structural part of the drive device or is part of a chassis or subchassis of the drive device.

20. The cleaning machine of claim 17, including magnet positioning/deployment means including at least one actuator assembly providing rotation positioning/deployment and/or retraction of at least one magnet.

21. The cleaning machine of claim 20, wherein the magnet positioning/deployment means includes cam actuated fine distance positioning of the respective magnet relative to the submerged surface.

22. The cleaning machine of claim 20, wherein the magnet positioning/deployment means includes include coarse positioning and fine positioning of the at least one magnet relative to the submerged surface.

23. The cleaning machine of claim 20, including at least one said magnet positioned towards a rear of the cleaning machine for attraction of the cleaning machine to the surface to be cleaned or being cleaned.

24. The cleaning machine of claim 20, wherein the at least one said magnet is positioned between the front and rear traction means of the cleaning machine.

25. The cleaning machine of claim 24, at least one said magnet positioned between two adjacent traction means of the drive device.

26. The cleaning machine of claim 1, wherein the at least one cleaning head includes at least one cleaning pod.

27. The cleaning machine of claim 26, wherein the at least one cleaning pod includes at least a forward or rearward pivot/swivel arrangement, or both a said forward and a said rearward pivot/swivel arrangement, such that the respective cleaning pod is enabled to pivot/swivel about a front to rear axis.

28. The cleaning machine of claim 27, including at least one castor or other wheel or track directly or indirectly supporting at least one said cleaning pod.

29. The cleaning machine of claim 26, wherein the at least one cleaning pod includes a body portion including a foam material.

30. The cleaning machine of claim 29, wherein the foam material includes a relatively hard foam material.

31. The cleaning machine of claim 29, wherein the foam material has a wear resistant/polymer coating.

32. The cleaning machine of claim 29, wherein the body portion is a replaceable or consumable wear part configured to be changed without the need to replace or remove the cleaning pod from the cleaning machine.

33. The cleaning machine of claim 17, wherein at least one support arrangement extends from the drive device to support at least a part of the respective cleaning head.

34. The cleaning machine of claim 33, wherein the support arrangement connects to the drive device between front and rear traction means of the drive device and projects to connect to the cleaning head.

35. A cleaning head for a cleaning machine for cleaning material from a submerged surface, the cleaning head including at least one cleaning pod, at least one said cleaning pod including a housing for a cleaning device, such as at least one rotatable blade, wherein the respective cleaning pod includes at least part of a pivot or swivel arrangement provided to allow the housing of the cleaning pod to pivot or swivel about a front to rear axis of the cleaning head or the cleaning machine.

36. A method of cleaning a submerged surface includes: disposing a cleaning machine on the submerged surface, cleaning the submerged surface while moving the cleaning machine across the submerged surface, and contacting traction means of the cleaning machine with the submerged surface within a width cleaned by at least one cleaning head of the cleaning machine.
